(19) United States
(12) Patent Application Publication
(10) Pub. No.: US 2005/0163029 A1
(43) Pub. Date: Jul. 28, 2005

(54) Recording medium recording medium reproduction method recording medium reproduction device unique identification recording method and recording medium recording device

(75) Inventor: Minoru Tobita, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Sony Corporation, Tokyo (JP)

(21) Appl. No.: 10/508,763

(22) PCT Filed: Mar. 28, 2003
(86) PCT No.: PCT/JP03/04032

(30) Foreign Application Priority Data
Mar. 29, 2002 (JP) 2002-098045

(51) Int. Cl. G11B 7/24; G11B 5/09

(52) U.S. Cl. 369/275.3; 369/275.4; 369/47.21

(57) ABSTRACT

Disclosed is an optical disc in which an area for recording the identification information proper to a recording medium may be provided in a location not obstructive to increasing the recording capacity without complicating the mechanism or processing for readout. To this end, a recording area for the identification information UID (unique ID), as the information proper to the disc, is provided inwardly of an area divided into 16 sectors, namely a sector 0 to a sector 15.

### Recording Medium, Method and Unit for Reproducing the Recording Medium, Method for Recording Intrinsic Identification Information and Recording Device for Recording Medium

### TECHNICAL FIELD

This invention relates to a recording medium, having data recorded on a track, wobbled in keeping with the address information, a method and a device for reproducing data recorded on the recording medium, a method for recording the intrinsic identification information for identifying the recording medium itself, and a device for recording on a recording medium.

This application claims priority of Japanese Patent Application No.2002-098045, filed in Japan on Mar. 29, 2002, the entirety of which is incorporated by reference herein.

### BACKGROUND ART

A small-sized optical disc, approximately 64 mm in diameter, having a recording capacity capable of recording music sound signals for 74 minutes or longer, is currently well known. This small-sized optical disc, termed a Mini-Disc (registered trademark), is classified into a replay-only disc, having data recorded as pits, and a recording and/or reproducing disc, having data recorded by a magneto-optical recording (MO) system and which may thus also be reproducible. The following description is directed to a small-sized recording and/or reproducing disc, referred to below as a magneto-optical disc. With this magneto-optical disc, the track pitch, the recording wavelength of the recording laser light or the NA of the objective lens has been improved in order to increase disc's recording capacity.

A magneto-optical disc of an initial stage, in which groove recording is carried out with the track pitch of 1.6 μm, with the modulation system being EFM, is termed the first generation MD. The physical format of this first generation MD is prescribed as follows: The track pitch is 1.6 μm and the bit length is 0.59 μm/bit. The laser wavelength λ is set to λ=780 nm and the numerical aperture of the optical head NA is set to NA=0.45. The recording system employed is the groove recording system in which a groove (i.e. a groove formed on the disc surface) is used as a track for recording and/or reproduction. The address system employed is a system employing the wobbled groove in which a single-spiral groove is formed on a disc surface and in which a wobble as the address information is formed on both sides of this groove. Meanwhile, in the present specification, the absolute address recorded by the wobbling is termed an ADIP (Address in Pre-Groove).

In a conventional Mini-Disc, the EFM (8-14 modulation) system is used as a modulation system for the recording data. As the error correction system, ACIRC (Advanced Cross Interleave Reed-Solomon Code) is used. For data interleaving, a convolution type data interleaving is used. In this manner, data redundancy amounts to 46.3%.

In the first generation MD, the data detection system is a bit-by-bit system, while the disc driving system used is the CLV (Constant Linear Velocity) system. The linear velocity of the CLV system is 1.2 m/sec.

The standard data rate during recording and/or reproduction is 133 kB/sec, while the recording capacity is 164 MB (140 MB for MD-DATA). The minimum data re-write unit (cluster) is constructed by 36 sectors composed of 32 main sectors and four link sectors.

Moreover, in these days, the next-generation MD, having a recording capacity further improved over the first generation MD, is being developed. Such an MD in which the medium is unchanged from the conventional medium (disc or cartridge), and in which the modulation system or the logical structure is changed to increase the data recording capacity to for example 300 MB, is now contemplated. This MD is referred to below as the next-generation MDI. The physical parameters of the recording medium are the same, the track pitch is 1.6 μm, the laser light wavelength λ is 780 nm and the numerical aperture of the optical head NA is 0.45. The recording system used is the groove recording system. The address system used is the ADIP. Thus, the structure of the optical system, ADIP address readout system and the servo processing in the disc driving device are similar to those of the conventional mini-disc.

An MD improved further in recording capacity over the aforementioned next-generation MD1, that is, the next-generation MD2, is now being developed, in which, while the outer shape and the structure of the optical system are compatible with the next-generation MD1, has a narrower track pitch of 1.25 μm and recording marks are detected from the groove by domain wall displacement detection (DWDD).

Meanwhile, the next-generation MD1 and the next-generation MD2 both allow for copying and are increased in recording capacity. Thus, if illegal copying is carried out between discs, the damage incurred is felt to be tremendous.

On the next-generation MD1, a discrimination number is recorded in a DDT (disc description table) as disc ID for uniquely identifying one of a large number of discs. This disc ID is recorded by a random number as 17PP signal at the time of formatting on the side of the recording and/or reproducing unit.

However, it may be anticipated that, in case an area for recording the discrimination number, such as the aforementioned disc ID, is provided in an address area in an optical disc, the recording capacity of which is to be increased, such as the next-generation MD2, difficulties are possibly encountered in increasing the recording capacity, while the mechanism or processing for readout is possibly complicated.

### DISCLOSURE OF THE INVENTION

In view of the above-depicted status of the art, it is an object of the present invention to provide a recording medium in which an area for recording the identification information proper to a disc may be provided in a location which is not obstructive to increasing the recording capacity of the recording medium, such as not to complicate the readout mechanism or processing.

It is another object of the present invention to provide a method and a device for a recording medium, in which the identification information may be read out from the optical disc and in which the recorded information on the disc is reproduced in keeping with the so read out identification information.

It is yet another object of the present invention to provide a method and a device for recording the identification information proper to the recording medium.

A recording medium according to the present invention includes a first area in which a track for data recording is formed in a wobbled manner and a second area in which no track for data recording is formed in a wobbled manner, and the intrinsic identification information for identifying the recording medium itself is recorded in the second area.

A method for reproducing a recording medium having a first area in which a track for data recording is formed in a wobbled manner and a second area in which no track for data recording is formed in a wobbled manner and in which the intrinsic identification information for identifying the recording medium itself is recorded, according to the present invention, includes causing movement of an optical head mechanism, having laser light illuminating means for illuminating laser light on the recording medium, to the second area, and reading out the intrinsic identification information from the return light of the laser light illuminated from the laser light illuminating means on the optical recording medium.

A reproducing apparatus for a recording medium having a first area in which a track for data recording is formed in a wobbled manner and a second area in which no track for data recording is formed in a wobbled manner, and in which the intrinsic identification information for identifying the recording medium itself is recorded, according to the present invention, comprises an optical head mechanism having laser light illuminating means for illuminating laser light on the recording medium, readout means for reading out the intrinsic identification information from the return light of the laser light illuminated from the laser light illuminating means of the optical head mechanism to the optical recording medium, and optical head mechanism controlling means for causing movement of the optical head mechanism to the second area to cause the readout means to read out the intrinsic identification information.

A method for recording the intrinsic identification information, according to the present invention, records the intrinsic identification information for identifying a recording medium itself in a second area of the recording medium where no wobbled track is formed. The recording medium also has a first area in which a data recording track is formed in a wobbled manner.

An apparatus for recording a recording medium having a first area in which a track for data recording is formed in a wobbled manner and a second area in which no track for data recording is formed in a wobbled manner, according to the present invention, includes an optical head mechanism having laser light illuminating means for illuminating laser light on the recording medium, and optical head mechanism controlling means for causing movement of the optical head mechanism to the second area and for illuminating laser light by the laser light illuminating means to cause the intrinsic identification information for identifying the recording medium to be written in the second area.

### BRIEF DESCRIPTION OF THE DRAWINGS

FIG. 1 shows a concrete example of an optical disc in a mirror part of which is recorded a UID recording area.

FIG. 2 shows division of the optical disc into plural zones.

FIG. 3 schematically shows the number of waves in the zones of the optical disc.

FIG. 4 shows a manner in which the number of waves of the wobbles between the neighboring tracks is made equal to each other.

FIG. 5 is a block diagram of a recording and/or reproducing unit for recording and/or reproducing information signals for a next-generation MD2.

FIG. 6 is a data format diagram for the next-generation MD2.

FIG. 7 is a format diagram of a UID.

FIG. 8 shows 32-byte UID data allocation.

FIG. 9 is a flowchart showing the processing sequence on the recording and/or reproducing unit in reading out the UID.

FIG. 10 is a block diagram showing a detailed structure of an ADIP decoder.

FIG. 11A is a waveform diagram of MORF signals and FIG. 11B is a waveform diagram for signals after passing through a bandpass filter.

FIG. 12 is a block diagram showing the structure of the recording and/or reproducing unit for an optical disc for recording and/or reproducing the Mini-Disc (first generation MD), and the next-generation MD1 and MD2.

FIG. 13 shows a data block structure including the BIS of the next-generation MD1 and MD2.

FIG. 14 shows the ECC data format for a data block of the next-generation MD1 and MD2.

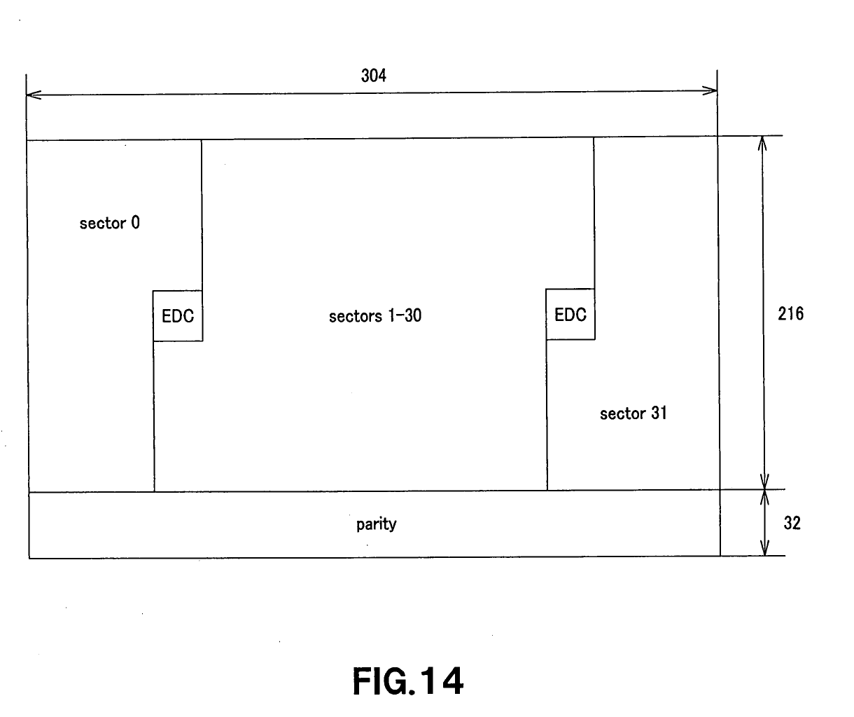

FIG. 15 illustrates the processing of embedding disc control signals in an ADIP signal of the next-generation MD2.

FIG. 16 schematically shows a typical area structure on a disc surface of the next-generation MD2.

FIG. 17A shows a data structure of the next-generation MD2 and FIG. 17B shows a data structure of the next-generation MD1.

FIG. 18 illustrates the processing of embedding a disc control signal in an ADIP signal of the next-generation MD2.

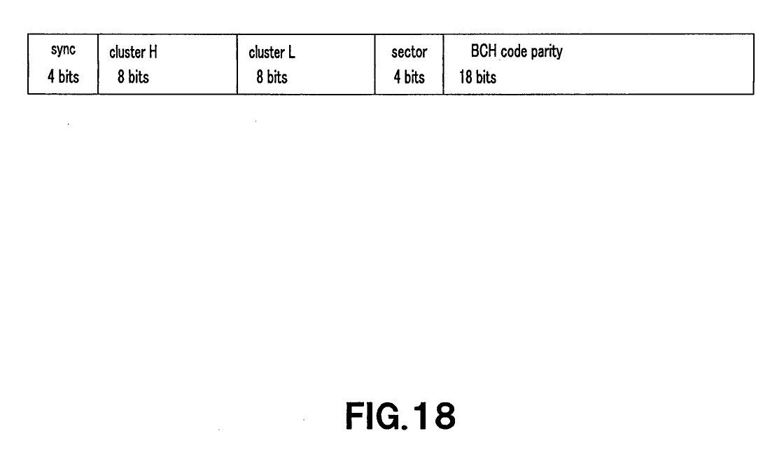

FIG. 19 is a block diagram showing the structure of a disc drive device.

FIG. 20 is a flowchart showing the processing in a system controller in the disc driving device in case a request is made from a PC for reading out a certain FAT sector.

FIG. 21 is a flowchart showing the processing in a system controller in the disc driving device in case a request is made from a PC for writing a certain FAT sector.

### BEST MODE FOR CARRYING OUT THE INVENTION

Referring to the drawings, preferred embodiments of the present invention are explained in detail.

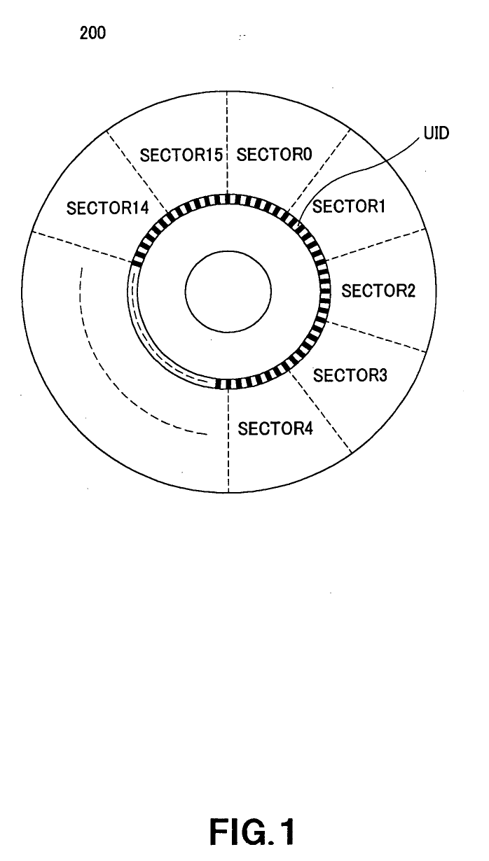

FIG. 1 shows a next-generation MD2 200 as a concrete example of the recording medium of the present invention. On a radially inner side of an area of the disc, divided into 16 sectors from sector 0 to sector 15, there is provided a recording area for the unique identification information UID (Unique ID) as the information proper to the disc.

The UID is the information recorded at the time of producing the disc, and is the intrinsic information for identifying the individual discs. This UID is used for copyright protection for the optical disc and for prohibiting e.g. data falsification.

The UID recording area is intrinsically a mirror area. That is, neither the groove nor bits are recorded therein. In this mirror area, an elongated mark, 200 μm×1 μm, for example, is recorded by MO recording. When the mark has been written on one track turn, PLL is applied, without applying the tracking, and an optical head for writing one track turn is fed. The elongated mark is then written in the same location with 200 μm in superposition such as to eliminate a gap. This forms a radially extending UID mark like a bar code. It is noted that the UID write pattern is of the format similar to that of ADIP. The FM modulation, bi-phase modulation and 3-bit correction BCH code are used, although the details are explained later. By so doing, the UID may be decoded using a decoder for the ADIP address on the recording and/or reproducing device, such that no dedicated UID reproducing circuit is needed. Moreover, the UID is recorded using wide marks as described above and hence may be reproduced by non-tracking.

The next generation MD2 for recording the UID in the mirror area is hereinafter explained. The next generation MD2 is a recording medium exploiting the high density recording technique, such as the domain wall displacement detection (DWDD), and differs in physical format from the above-described conventional Mini-Disc or from the next-generation MD1. The next-generation MD2 has a track pitch of 1.25 μm and a bit length of 0.16 μm/ bit and is of a high recording density along the line direction.

For compatibility with the conventional Mini-Disc and with the next-generation MD1, the optical system, readout system or the servo processing is in keeping with those of the conventional standard. The laser wavelength λ is 780 nm, with the numerical aperture of the optical head NA being 0.45. The recording system is the groove recording system, with the address system being a system exploiting the ADIP. The outer shape of a casing is of the same standard as that of the conventional Mini-Disc and the next-generation MD1.

However, for reading out the track pitch and the line density (bit length) narrower than those of the conventional Mini-Disc and the next-generation MD1, using the optical system equivalent to that used for the conventional Mini-Disc and the next-generation MD1, it is necessary to resolve the detrack margin, crosstalk from the land and the groove, wobble crosstalk, focusing leakage or constraint conditions in e.g. the CT signal. Thus, the next-generation MD2 is featured by changes in the groove depth, tilt or width. Specifically, the depth, tilt and the width of the groove are set to 160 to 180 nm, 60° to 70° and to 600 nm to 800 nm, respectively.

As the recording data modulating system, the next-generation MD2 uses the RLL (1-7) PP (run length limited parity reserve/prohibit rmtr (repeated minimum transition run length)) modulation system. As the error correction system, an RS-LDC (Reed Solomon-Long Distance Code) with BIS (burst indicator subcode) with higher correction capability, is used. The data interleaving is of the block completion type. Hence, the redundancy of the data is 20.50%. The data detection system used is is the viterbi decoding system by PR (1, −1)ML. The cluster, as the smallest rewrite unit, is made up by 16 sectors (64 kB).

The disc driving system used is the ZCAV (zone CAV) system. The line velocity is 2.0 m/s. In the ZCAV system, reproduction is by CAV in the same zone. In the recording and/or reproducing unit, it appears as if the disc is rotationally driven with CAV, with the spindle motor being controlled as conventionally.

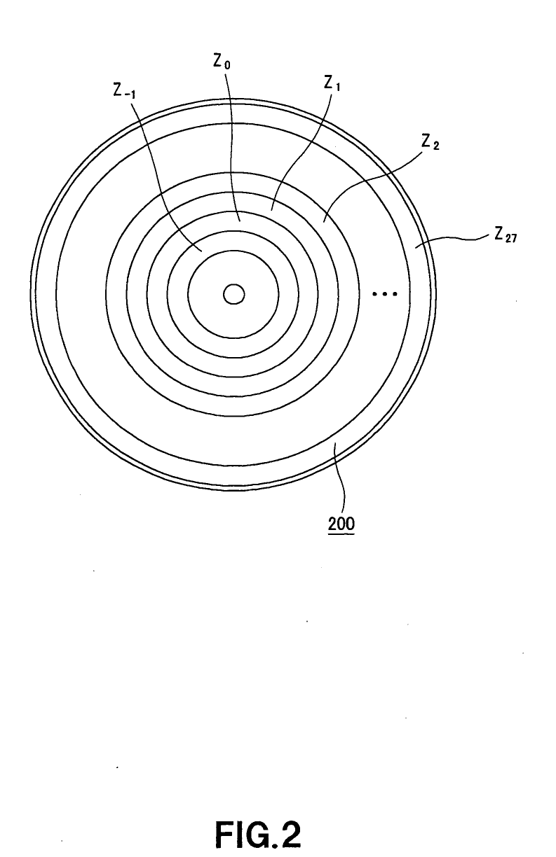

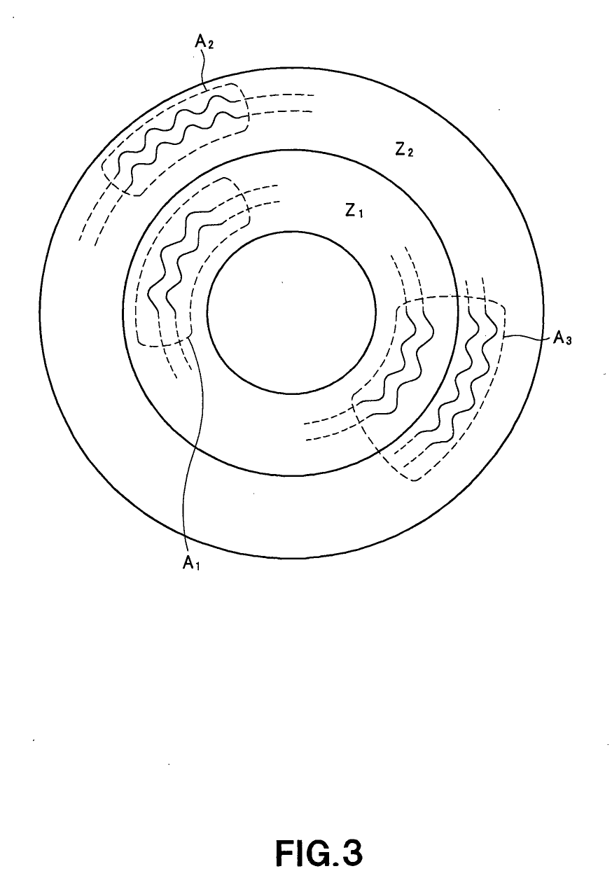

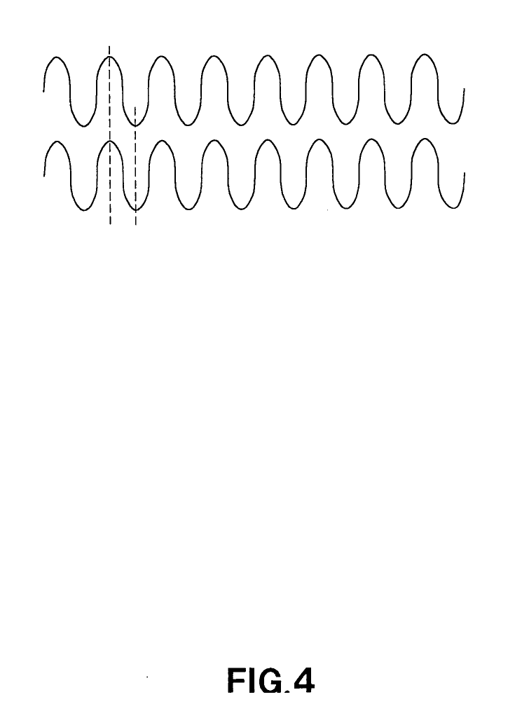

FIG. 2 shows a zoning format for an optical disc 200, such as the next-generation MD2, driven in accordance with the ZCAV system. In this optical disc 200, the area of the disc is divided into 28 zones of zone Z₀ to zone Z₂₇. In each zone, the number of waves (phase) of the wobble is made coincident between neighboring tracks. For example, in FIG. 3, showing the zones Z₁ and Z₂ to an enlarged scale, the number of waves (phase) is made coincident within the zone Z₁, as shown surrounded in an area A₁. Within the zone Z₂, the number of waves (phase) is made coincident, as shown surrounded in an area A₁. The wobbles in the area A₁ and area A₂ are taken out and shown in FIG. 4. The numbers of the waves are equal, meaning that the numbers of the ADIP carrier waves are made equal. This enables the in-phase and out-phase to be matched to each other on an average. Meanwhile, the number of waves (phase) does not need to be coincident between the neighboring zones Z₁ and Z₂, as shown surrounded in an area A₃.

With the use of the above-described ZCAV system, the standard data rate in recording and/or reproduction is 9.8 MB/s. In the next-generation MD2, employing the DWDD system and the ZCAV system, the total recording capacity may be 1 GB.

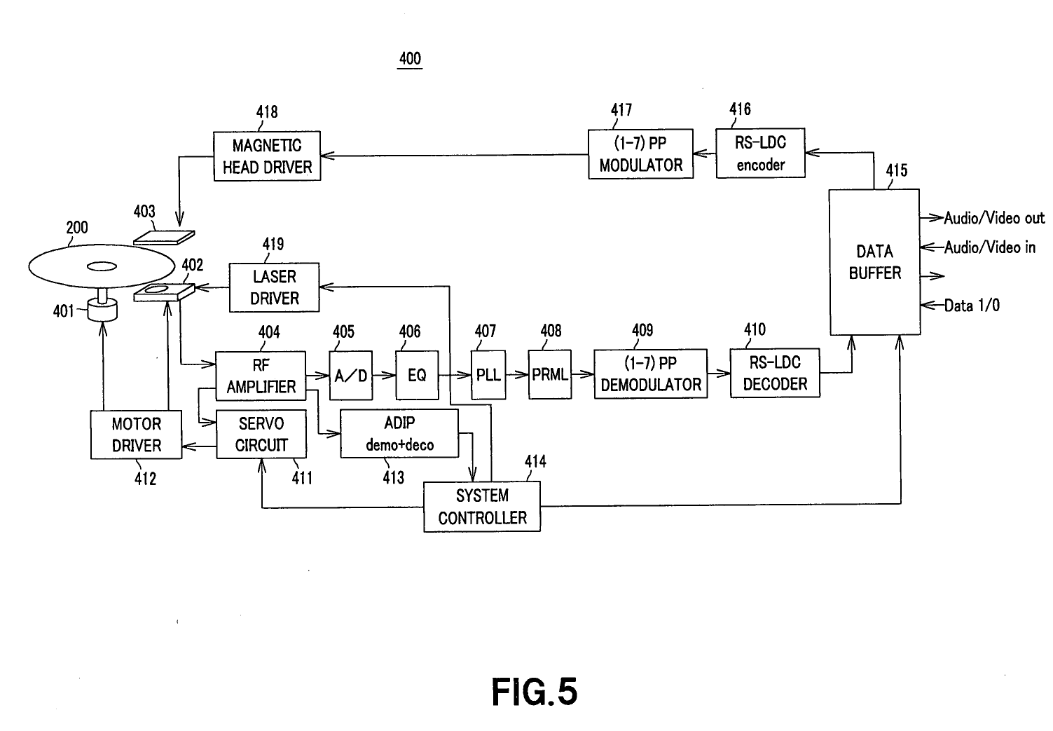

The recording and/or reproducing unit for an optical disc, recording and/or reproducing information signals for the next-generation MD2, is now explained with reference to FIG. 5. This recording and/or reproducing unit for an optical disc has a structure for executing the RLL (1-7) PP modulation RS-LDC encoding for recording on the next-generation MD2, and for executing RLL (1-7) demodulation RS-LDC decoding, based on data detection employing viterbi decoding and PR (1, −1) ML for reproducing the next-generation MD2.

In this recording and/or reproducing unit for an optical disc, the next-generation MD2 (200), loaded in position, is rotationally driven by a spindle motor 401, in accordance with the above-described ZCAV system. During recording or reproduction, the laser light is illuminated from an optical head 402 on this next-generation MD2 (200).

During recording, the optical head 402 outputs a laser light beam of a high level for heating the recording track to the Curie temperature. During reproduction, the optical head 402 outputs a laser light beam of a lower level for detecting data from the reflected light by the magnetic Kerr effect. To this end, the optical head 402 has mounted thereon a laser diode, as laser outputting means, an optical system including a polarizing beam splitter or an objective lens, and a detector for detecting the reflected light. The objective lens, provided to the optical head 402, is retained by e.g. a biaxial mechanism for movement in a direction along the radius of the disc and in a direction towards and away from the disc,

A magnetic head 403 facing the optical head 402, with the interposition of the next-generation MD2, there is arranged a magnetic head 403 for applying a magnetic field, modulated by recording data, on the next-generation MD2. There are provided a sled motor and a sled mechanism for causing movement of the entire optical head 402 and the magnetic head 403 in the direction along the radius of the disc.

The present recording and/or reproducing unit for the optical disc includes a recording processing system, a reproducing processing system and a servo system, in addition to the recording and/or reproducing head system, including the optical head 402 and the magnetic head 403, and the disc rotating driving system, including the spindle motor 401. The recording processing system includes a part for executing the RLL (1-7) PP modulation and RS-LDC encoding during recording on the next-generation MD2.

The reproducing processing system includes parts for executing the demodulation PR(1, −1)ML, associated with the RLL (1-7) PP modulation, RLL (1-7) demodulation and RS-LDC decoding, during the reproduction of the next-generation MD2.

The information detected as the reflected light by laser light illumination by the optical head 402 on the next-generation MD2 (current transduced from light obtained on detection of the reflected laser light by the photodetector) is sent to an RF amplifier 404. The RF amplifier 404 performs current-voltage conversion, amplification and matrix operations on the input detected information to extract e.g. the reproduced RF signals, as the reproduced information, tracking error signals TE, focusing error signals FE and the groove information (ADIP information recorded as track wobbling on the next-generation MD2).

During reproduction of the next-generation MD2, the replay RF signals, obtained by an RF amplifier, are processed through an A/D converter 405, an equalizer 406, a PLL circuit 407 and a PRML circuit 408 by an RLL (1-7) PP demodulator 409 ands an RS-LDC decoder 410. The replay RF signals are sent to the RLL (1-7) PP demodulator 409 where reproduced data is produced as a RLL (1-7) codestring by PR (1, −1) ML and viterbi decoding. The RLL (1-7) demodulation is executed on this RLL (1-7) codestring. The so processed data is error-corrected and deinterleaved in the RS-LDC decoder 410. The modulated data is output to a data buffer 415 as reproduced data from the next-generation MD2.

The tracking error signals TE and the focusing error signals FE, output from the RF amplifier 404, are sent to a servo circuit 411, while the groove information is sent to an ADIP decoder 413.

In the ADIP decoder 413, wobble components are extracted by bandwidth limitation on the groove information by a bandpass filter. The ADIP address is extracted by FM demodulation and bi-phase demodulation. The extracted ADIP address, as the extracted absolute address information on the disc, is sent to a system controller 414 as the address for the next-generation MD2.

The system controller 414 executes preset control processing, based on the ADIP address. The groove information is returned to the servo circuit 411 for spindle servo control.

The servo circuit 411 generates spindle error signals for ZCAV servo control based on an error signal obtained on integrating the phase error with respect to the reproducing clocks (clocks of the PLL system during decoding) relative to the groove information.

The servo circuit 411 also generates a variety of servo control signals, including tracking control signals, focusing control signals, sled control signals and spindle control signals, based on the tracking error signals or focusing error signals, supplied from the RF amplifier 404, or track jump or access commands from the system controller 414, to output the generated signals to a motor driver 412. That is, the servo circuit carries out the needed processing, such as phase compensation, gain processing or target value setting, responsive to the servo error signals or commands, to generate various servo control signals.

The motor driver 412generates preset servo driving signals, based on servo control signals supplied from the servo circuit 411. The servo driving signals here include biaxial driving signals driving the biaxial mechanism (in the focusing and tracking directions), sled motor driving signals, driving the sled mechanism, and spindle motor driving signals for driving the spindle motor 401. The focusing and tracking control for the next-generation MD2 and the ZCAV control for the spindle motor 401 are carried out by these servo driving signals.

In executing the recording on the next-generation MD2, high density data are supplied from a memory transfer controller, not shown, or usual ATRAC compressed data are supplied from an audio processor.

During recording on the next-generation MD2, an RS-LCD encoder 416 and an RLL (1-7) PP modulator 417 are in operation. In this case, an error correction code of the interleaving system and the RS-LDC system are appended to the high density data in the RS-LCD encoder 416 and the resultant data is RLL (1-7) modulated by the RLL (1-7) PP modulator 417.

The recording data, modulated into the RLL (1-7) codestring, are sent to a magnetic head driver 418. The magnetic head 403 applies the magnetic field, based on modulated data, to the next-generation MD2 to record data.

A laser driver/APC 419 causes a laser diode to execute the laser light emitting operation during replay and recording as described above. In addition, the laser driver/APC 419 performs so-called APC (automatic laser power control) operations. Specifically, a detector for monitoring the laser power, not shown, is provided within the optical head 402, and a monitor signal from the detector is fed back to the laser driver/APC 419. The laser driver/APC 419 compares the current laser power, obtained as a monitor signal, to a preset laser power and causes an error component to be reflected in a laser driving signal to perform control so that the power of the laser output from the laser diode will be stabilized at a preset value. The laser power, as the replay laser power and the recording laser power, is set by the system controller 414 in a register within the laser driver/APC 419.

The system controller 414 controls respective components to allow execution of the above-described various operations (the operations of laser driving, access, various servo, data write and data readout operations).

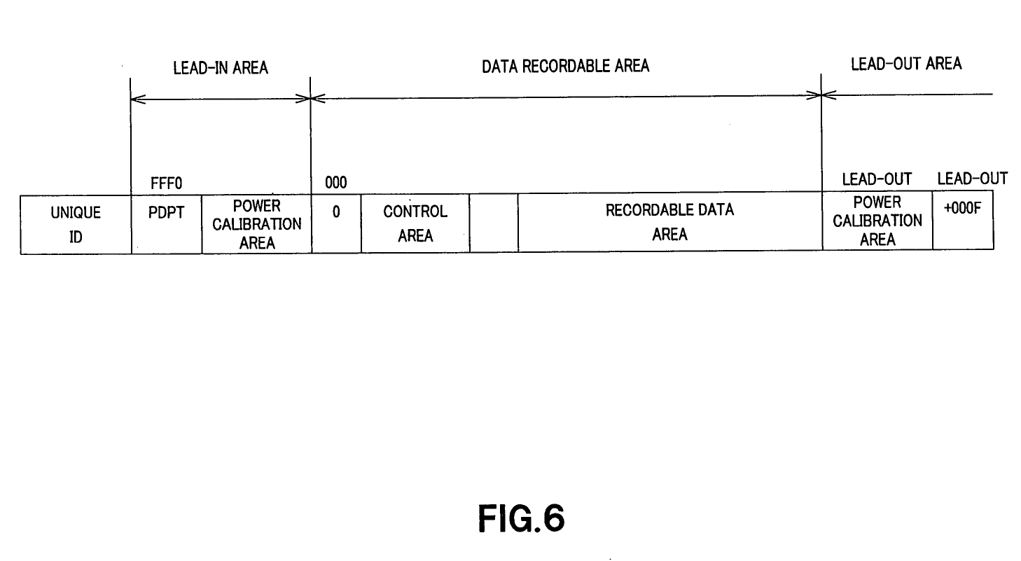

FIG. 6 shows the data format of the next-generation MD2. A data recordable area is provided as it is sandwiched between the lead-in area and the lead-out area. In the lead-in area, there are provided a recording area for the UID, a PDPT (PreFormat Disc Parameter Table), as a parameter table proper to the disc, and a power calibration area. In the data recordable area, there are provided a control area and a recordable data area. In the lead-out area, there is provided a lead-out power calibration area.

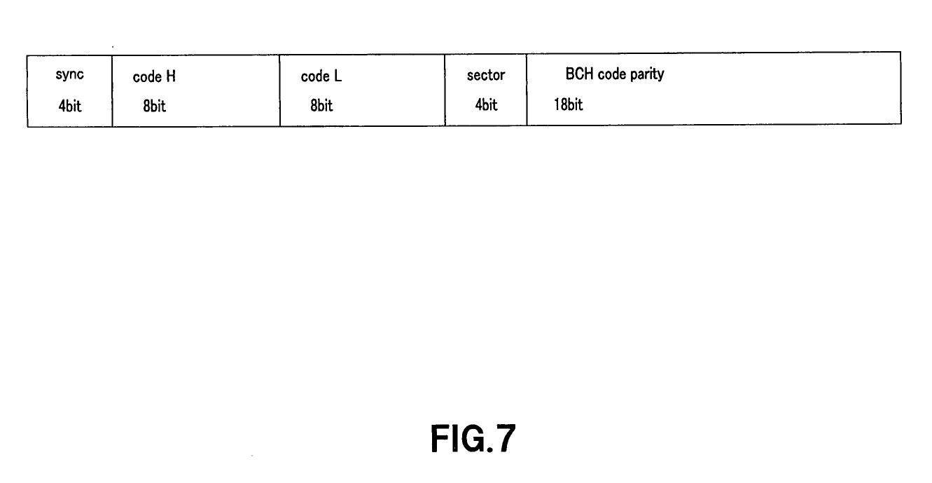

FIG. 7 shows the UID format, which is the same in configuration as the ADIP format as later explained. That is, a synchronizing signal is 4 bits, a code H is expressed by 8 bits, a code L is expressed by 8 bits, a sector is expressed by 4 bits, and the BCH code parity is expressed by 18 bits, totaling at 42 bits. The UID data is written in a sum total of 16 bits (2 bytes) of the code H and the code L. 16 sectors each of the 16 bits (2 bytes) are collected to form the UID data of 32 bytes (256 bits).

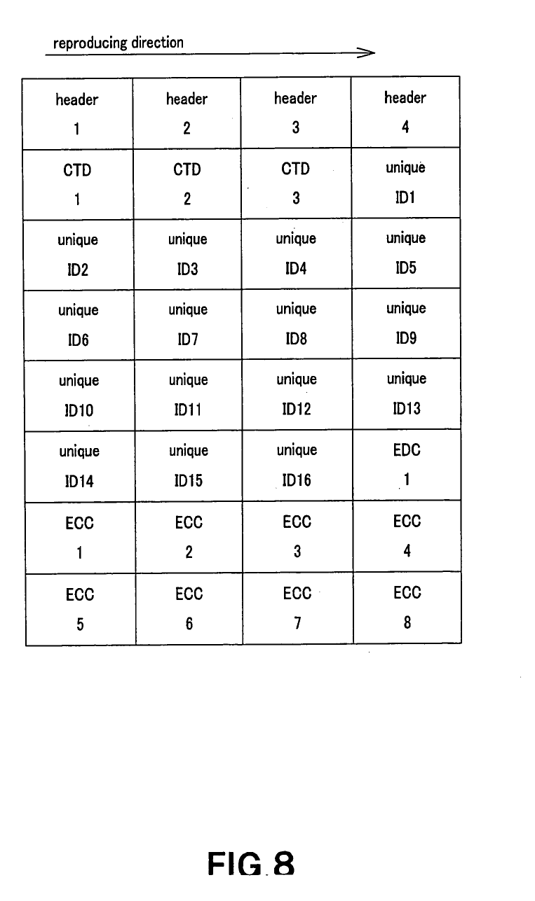

Referring to FIG. 8, the UID data are entered in 8 rows, each containing 4 bytes in the reproducing direction. The UID data begins with 4 bytes of the header, followed by 3 bytes of control data (CD), followed in turn by 16 bytes of the unique codes. A byte of the error detection code (EDC) is then appended and is followed by 8 bytes of the error correction code (ECC).

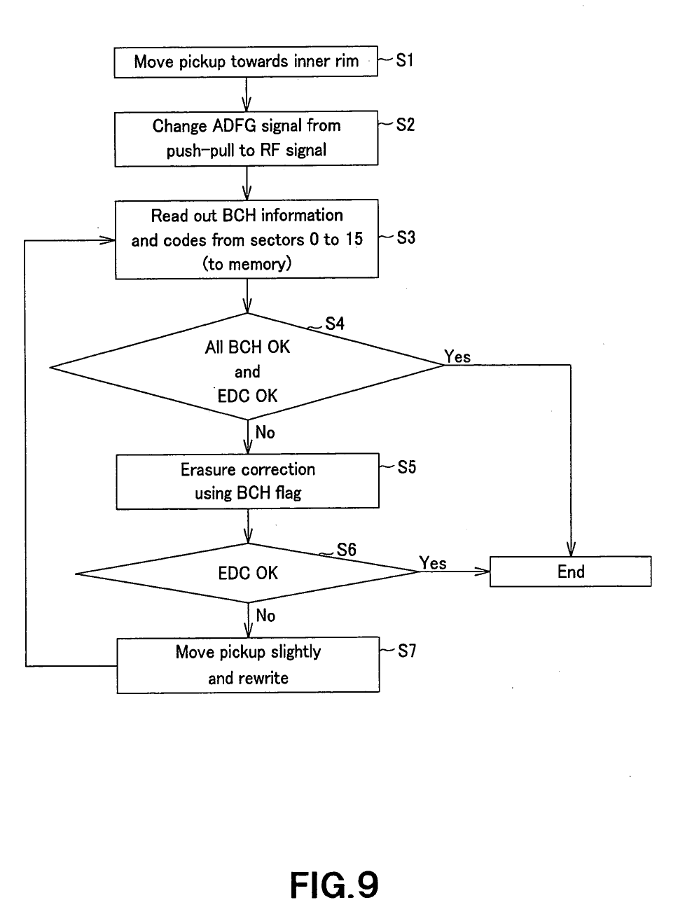

FIG. 9 depicts a flowchart showing the processing sequence executed by the system controller 414 of the recording and/or reproducing unit for the optical disc in reading out the UID.

First, in a step S1, the optical head 402 is moved to the inner rim of the disc. Since the ADIP address is formed up to the PDPT, access may be made up to this point with the address. If the optical head 402 is then driven towards the inner rim of the disc, the optical head 402 reaches the UID recording area. A detection switch, not shown, may be provided in this location for mechanically detecting the optical head 402 reaching the UID recording area.

At the next step S2, the ADFG signal, read in from the RF amplifier 404 to the ADIP decoder 413, is switched from a push-pull signal to an RF signal. The ADFG signal is a comparator output of the ADIP wobble signal. The wobble may be detected from the push-pull signal. On the other hand, the UID is written in MO. Thus, when reading in the UID, it is sufficient to detect the ADFG signal as the RF signal.

At the next step S3, the BCH signal and the codes from the sector 0 to the sector 15 are read out from the ADIP decoder 413 and stored in a memory. If it is found in a step S4 that all BCHs are correct and the EDC is also correct, the codes are read to the ends to complete the processing. If there is an error such that the result of check at the step S4 is NO, the system controller proceeds to a step S5 to execute erasure correction using a flag of the BCH information stored in the memory in the step S3.

If the EDC is regular in a step S6, the UID is read to its end. If the EDC is not regular, the system controller proceeds to a step S7 to cause the pickup to be moved a small distance for re-trial.

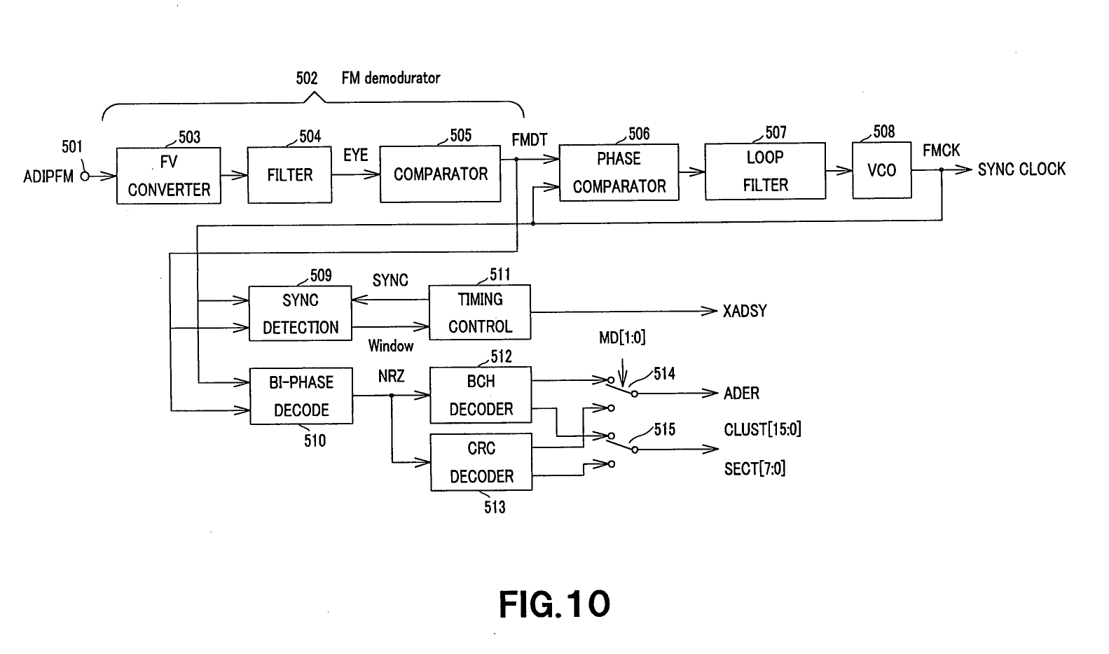

FIG. 10 shows the detailed structure of the ADIP decoder 413.

If the ADFG (ADIPFM) is supplied via an input terminal 501 from the RF amplifier 404, an FV converter 503 in an FM demodulator 502 converts the frequency into a voltage signal. This voltage signal is filtered through a filter 504 and binary coded by a comparator 505. The resultant FMDT is sent to a phase comparator 506, a sync detection circuit 509 and to a bi-phase decoder 510.

An output of the FMDT from the phase comparator 506 is processed by a PLL, made up by a loop filter 507 and a VCO 508, into sync clocks FMCK, which are then supplied to the phase comparator 506, a sync detector 509 and a bi-phase decoder 510.

The sync detector 509 detects the sync from the FMDT, in accordance with the sync clocks FMCK, to send the so detected sync to a timing circuit 511, which timing circuit 511 generates a sector pulse XADSY to send the so generated sector pulse to the system controller 414. The timing circuit 511 also sends the window information Window to the sync detector 509.

The bi-phase decoder 510 bi-phase decodes the FMDT, based on the sync clocks FMCM, to send NRZ data to a BCH decoder 512 and to a CRC decoder 513. In the present embodiment, the BCH decoder 512 and the CRC decoder 513 are connected in parallel with each other and outputs of the respective decoders are changed over using changeover switches 514, 515 to take out the UID address error ADER, cluster position number and the sector number, which is used as the information on the rotation. The UID data are also taken out via switching between these changeover switches 514, 515 from the BCH decoder 512 and the CRC decoder 513.

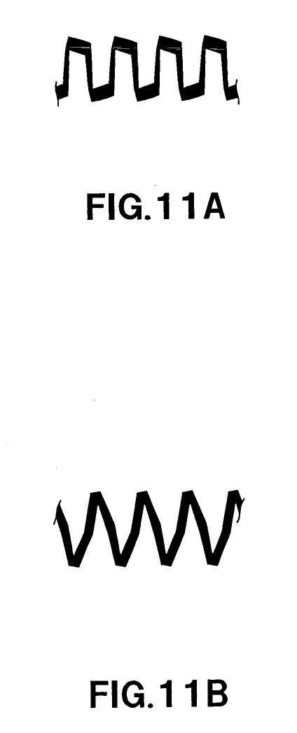

Meanwhile, the next-generation MD2 reproduces data from the groove by ultra-resolution reproduction by DWDD. However, the UID is reproduced by the usual replay mode, without employing the ultra-resolution reproduction, such as DWDD. If the RF signals from the RF amplifier 404, with the waveform shown in FIG. 11A, are filtered by a bandpass filter, a signal shown in FIG. 11B is obtained. This signal may be read by the ADIP decoder 413.

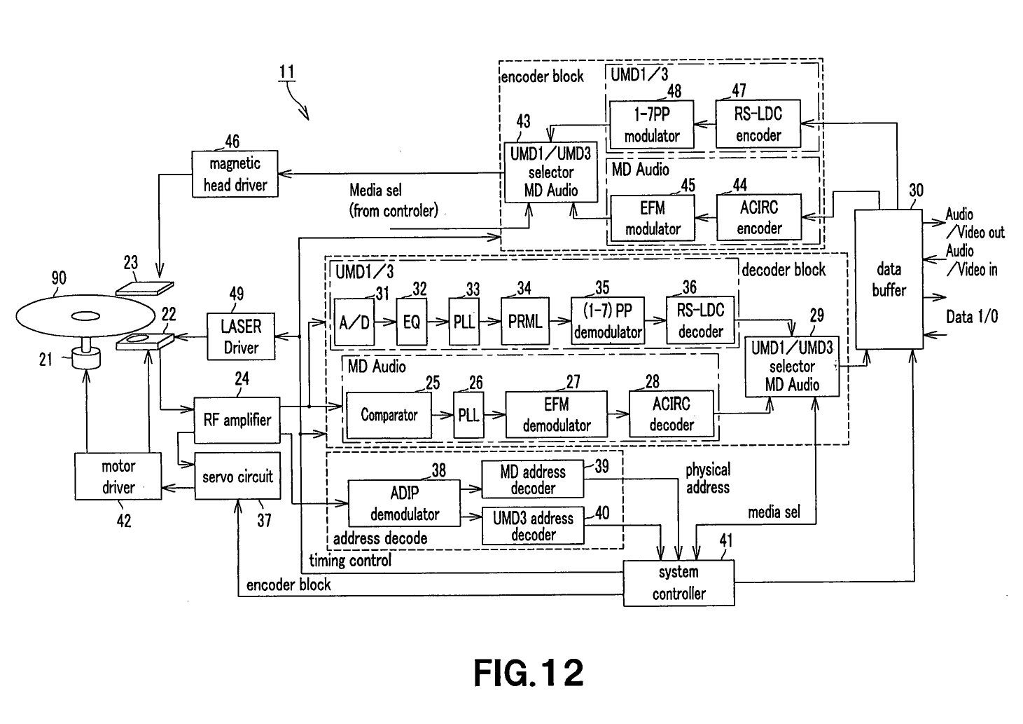

FIG. 12 shows the structure of a recording and/or reproducing unit for an optical disc 11 for recording and/or reproducing the conventional Mini-Disc (first-generation Mini-Disc), the next-generation MD1 and the next-generation MD2. This recording and/or reproducing unit for an optical disc 11 discriminates the next-generation MD1 and the next-generation MD2. However, there are occasions where the recording and/or reproducing unit for an optical disc 11 discriminates the first generation MD and the next-generation MD2.

The recording and/or reproducing unit for the optical disc 11 is featured by including, for recording and/or reproducing the conventional Mini-Disc, the next-generation MD1 and the next-generation MD2, an arrangement for executing EFM modulation and ACIRC encoding for recording the conventional Mini-Disc and an arrangement for executing the RLL (1-7) PP modulation and RS-LDC encoding for recording the next-generation MD1 and the next-generation MD2. The recording and/or reproducing unit for the optical disc 11 is also featured by including, as a replay processing system, an arrangement for executing EFM demodulation and ACIRC decoding for reproducing the conventional Mini-Disc and an arrangement for executing RLL (1-7) demodulation RS-LDC decoding based on data detection employing PR (1, 2, 1) ML, PR (1, −1) ML and viterbi decoding for reproducing the next-generation MD1 and the next-generation MD2.

In the recording and/or reproducing unit for the optical disc 11, a disc 90 loaded thereon is rotationally driven by the spindle motor 21 in accordance with the CLV system or the ZCAV system. During recording and/or reproduction, laser light is illuminated from the optical head 22 on the disc 90.

The optical head 22 outputs high-level laser light for heating the recording track to the Curie temperature during recording, while outputting laser light of a relatively low level for detecting the data from the reflected laser light by the magnetic Kerr effect. To this end, the optical head 22 includes a laser diode as laser outputting means, an optical system including a polarizing beam splitter and an objective lens, and a detector for detecting the reflected light. The objective lens, mounted to the optical head 22, is held by for example a biaxial mechanism for displacement in the radial direction of the disc and in a direction towards and away from the disc. The optical head 22 is provided with a photodetector PD for supplying a received light signal A and a received light signal B in an optical disc discriminating device enclosed therein. Since it is necessary to determine the proceeding direction, at the time of discriminating the optical disc, the objective lens or the entire optical head 22 is moved at a constant velocity from an inner rim towards an outer rim of the optical disc. The received light signal A and the received light signal B may be detected at a speed sufficient to overcome the amount of movement caused by the offset.

In the present embodiment, a phase compensation plate is provided on the readout light path of the optical head 22 in order to develop the maximum replay characteristics for the next-generation MD1 and the next-generation MD2 having different physical design parameters on the medium surface. By this phase compensation plate, the bit error rate during readout may be optimized.

A magnetic head 23 is arranged in a location facing the optical head 22 with the disc 90 in-between. The magnetic head 23 applies a magnetic field, modulated by recording data, to the disc 90. Although not shown, a sled motor and a sled mechanism are provided for causing movement of the optical head 22 in its entirety and the magnetic head 23 along the radius of the disc. When the optical disc discriminating unit discriminates the optical disc, the sled motor and the sled mechanism are moved from the inner rim towards the outer rim of the optical head 22.

The recording and/or reproducing unit for the optical disc 11 is provided with a recording processing system, a reproducing processing system and a servo system, in addition to the recording and/or reproducing head system composed of the optical head 22 and the magnetic head 23, and to the disc rotating driving system by the spindle motor 21. As the recording processing system, there are provided a unit responsible for EFM modulation and ACIRC encoding at the time of recording on a conventional Mini-Disc and a unit responsible for RLL (1-7) PP modulation and RS-LDC encoding at the time of recording on the next-generation MD1 and the next-generation MD2.

As the reproducing processing system, there are provided a unit responsible for demodulation as a counterpart operation for EFM modulation, and ACIRC decoding at the time of reproducing the conventional Mini-Disc, and a unit responsible for demodulation (PR(1,2,1) ML and RLL (1-7) demodulation based on data detection employing viterbi decoding) and for RS-LDC decoding, as a counterpart operation for the RLL (1-7) PP modulation at the time of reproducing the next-generation MD1 and next-generation MD2.

The information detected as the reflected light of the illuminated laser light on the disc 90 of the optical head 22 (optical current obtained on detecting the reflected laser light by the photodetector) is routed to an RF amplifier 24. This RF amplifier 24 executes current-voltage conversion, amplification and matrix calculations on the detected input information to extract the replay RF signals, tracking error signals TE, focusing error signals and the groove information (ADIP information recorded on the disc 90 by track wobbling) as the replay information.

In this RF amplifier 24, there are enclosed a tracking error signal calculating unit 221, forming the optical disc discriminating unit 220, a pull-in signal calculating unit 225, and comparator 222 and 226.

For reproducing the conventional Mini-Disc, the replay RF signals, obtained in the RF amplifier, are processed through the comparator 25 and the PLL circuit 26 by an EFM demodulating unit 27 and an ACIRC decoder 28. The replay RF signals are turned into bi-level signals by the EFM demodulating unit 27 and turned into an EFM signal string, which then is EFM demodulated, corrected for errors and deinterleaved in the ACIRC decoder 28. If the signals are audio data, the data at this time point are ATRAC compressed data. At this time, the conventional Mini-Disc signal side of the selector 29 is selected and the demodulated ATRAC compressed data are output as replay data from the disc 90 to the data buffer 30. In this case, the compressed data is supplied to the audio processing unit, not shown.

On the other hand, in reproducing the next-generation MD1 or the next-generation MD2, the replay RF signals, obtained by the RF amplifier, are processed by an RLL (1-7) PP demodulating unit 35 and an RS-LDC decoder 36, via an A/D converting circuit 31, an equalizer 32, a PLL circuit 33 and a PRML circuit 34. As for the replay RF signals, replay data, as an RLL (1-7) code string, is obtained by data detection employing PR (1, 2, 1) ML and viterbi decoding, in the RLL (1-7) PP demodulating unit 35. On this RLL (1-7) code string, RLL (1-7) demodulation processing is carried out. The resulting data is corrected for errors and deinterleaved in the RS-LDC decoder 36.

In this case, the next-generation MD1-the next-generation MD2 side of the selector 29 is selected, such that the demodulated data is output as replay data from the disc 90 to the data buffer 30. The demodulated data is then supplied to a memory transfer controller, not shown.

The tracking error signals TE and the focusing error signals FE, output from the RF amplifier 24, are supplied to a servo circuit 37, while the groove information is supplied to an ADIP decoder 38.

The ADIP decoder 38 limits the bandwidth of the groove information by a band-pass filter to extract wobble components and subsequently effectuates FM modulation and bi-phase demodulation to extract the ADIP address. If the disc is the conventional Mini-Disc or the next-generation MD1, the ADIP information as the absolute information on the disc is supplied to a driving controller 41 through a MD address decoder 39, whereas, if the disc is the next-generation MD2, the ADIP information is supplied to the driving controller 41 through a next-generation MD2 address decoder 40.

The driving controller 41 executes preset control processing based on each ADIP address. The groove information is returned to the servo circuit 37 for spindle servo control.

The driving controller 41 is provided with the function of a D-flipflop discriminating circuit making up the optical disc discriminating device. The driving controller 41 discriminates the sort of the MD based on the result of discrimination by the D-flipflop discriminating circuit 224.

Based on error signals, obtained on integrating the phase error between the groove information and the replay clocks (PLL-based clocks at the time of decoding), the servo circuit 37 generates spindle error signals for CLV servo control and for ZCAV servo control.

Based on the spindle error signals, tracking and focusing error signals, supplied form the RF amplifier 24, or track jump command or access command, from the driving controller 41, the servo circuit 37 generates various servo control signals, such as tracking control signals, focusing control signals, sled control signals or spindle control signals, and outputs these servo control signals to the motor driver 42. That is, the servo circuit 37 performs phase compensation processing, gain processing or target value setting processing, as needed, on servo error signals or commands, to generate various servo control signals.

Based on the servo control signal, supplied from the servo circuit 37, the motor driver 42 generates preset servo driving signals. These servo control signals prove sled motor driving signals (two driving signals, namely the signal for the focusing direction and that for the tracking direction) actuating the biaxial mechanism, a sled motor driving signal, driving the sled mechanism, and a spindle motor driving signal, driving the spindle motor 21. By these servo driving signals, the focusing control and tracking control for the disc 90 and the CAV or ZCAV control for the spindle motor 21 is exercised.

In discriminating the optical disc, the optical disc discriminating unit controls the servo circuit 37 and the motor driver 42, by the driving controller 41, to turn on the focusing of the laser light by the objective lens of the optical head 22. The tracking servo is not applied. The sled servo is such as to cause the optical head 22 to be moved from the inner rim towards the outer rim at a certain velocity.

In recording on the disc 90, high density data is supplied from a memory transfer controller, not shown, or usual ATRAC compressed data is supplied from an audio processing unit.

In recording on the conventional Mini-Disc, the selector 43 is connected to a conventional Mini-Disc side, such that an ACIRC encoder 44 and an EFM modulating unit 45 are in operation. When the input is an audio signal, compressed data from an audio processing unit 19 is interleaved and added by an error correction code by the ACIRC encoder 44 so as to be then EFM modulated by the EFM modulating unit 45. The EFM modulated data are supplied via selector 43 to a magnetic head driver 46 which then causes the magnetic head 23 to apply a magnetic field corresponding to the EFM modulated data to the disc 90 to record modulated data.

During recording on the next-generation MD1 and on the next-generation MD2, the selector 43 is connected to the next-generation MD1-next-generation MD2 side, such that an RS-LCD encoder 47 and an RLL (1-7) PP modulation unit 48 are in operation. In this case, the high density data, sent from a memory transfer controller 12, are interleaved and added by an error correction code of the RS-LDC system, in the RS-LCD encoder 47, and subsequently RLL(1-7) demodulated by the RLL (1-7) PP modulation unit 48.

The recording data, modulated into the RLL (1-7) codestring, are supplied via selector 43 to a magnetic head driver 46, and recorded by the magnetic head applying a magnetic field corresponding to the modulated data on the disc 90.

A laser driver/APC 49, which causes a laser diode to emit laser light during reproduction and recording, as described above, also performs so-called APC (automatic laser power control) operations. Specifically, a laser power monitoring detector, not shown, is provided in the optical head 22, for outputting a monitor signal, which is fed back to the laser driver/APC 49. This laser driver/APC 49 manages control for stabilizing the laser power, output from the laser diode, at a preset value, by comparing the current laser power, obtained as a monitor signal, to a preset laser power, and by having an error reflected in the laser driving signal. By way of the laser power, a value as the reproducing laser power and a recording laser power are set in a register within the laser driver/APC 49 by the driving controller 41.

The driving controller 41 controls the various components, under commands from a system controller 18, for executing the above-described various operations (operations for access, servo data write and data readout operations). In FIG. 9, the parts encircled with a chain-dotted line may be formed by a one-chip circuit.

The logical and physical formats of the next-generation MD1 and on the next-generation MD2 are hereinafter explained in detail.

Similarly to the next-generation MD1, the next-generation MD2 uses, as the modulating system for the recording data, the RLL (1-7) PP modulation system (run length limited parity preserve/ prohibit rmtr (repeated minimum transition run length)) modulation system. As the error correction system, an RS-LDC (Reed Solomon-Long Distance Code) with BIS (burst indicator subcode) with higher correction ability, is used.

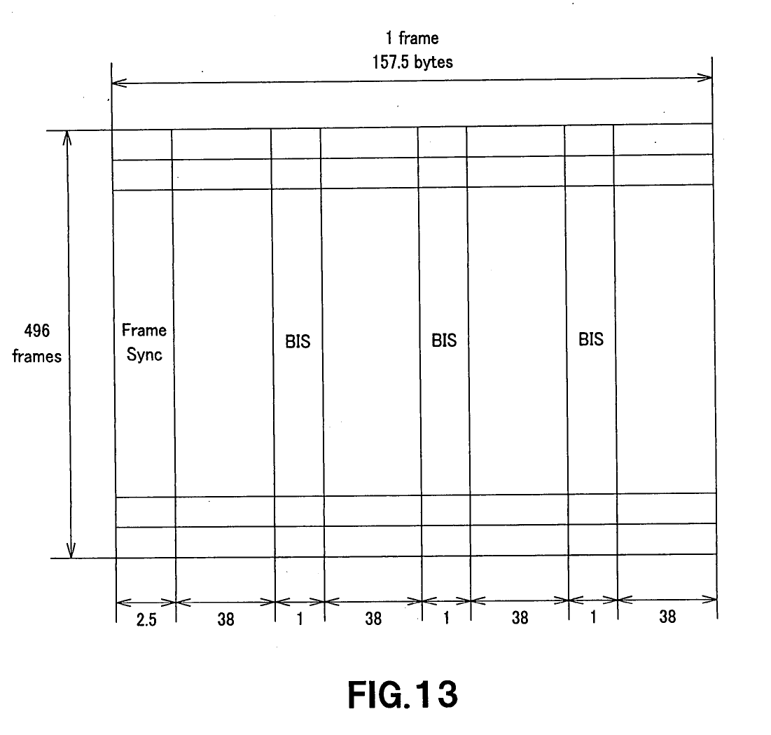

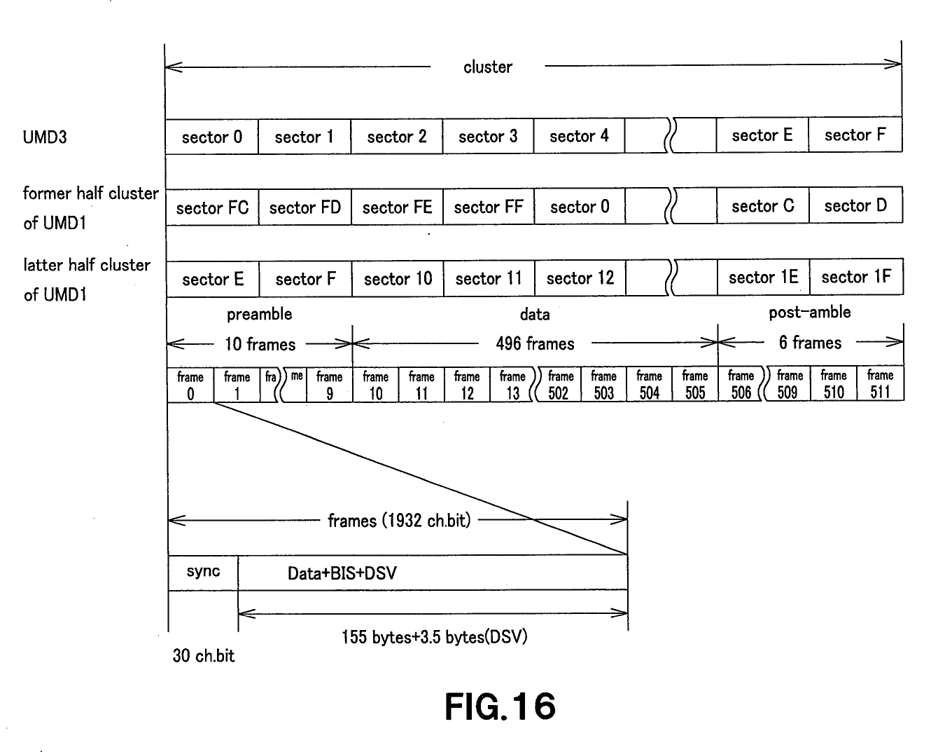

Specifically, 2052 bytes, obtained on appending 4-byte EDC (error detection code) to 2048 bytes of user data, supplied from e.g. a host application, is one sector (data sector different from a physical sector on the disc as later explained) and 32 of such sectors are gathered in a block of 304 columns ×216 rows. It is noted that 2052 bytes of each sector are scrambled such as to take the Ex-Or of preset pseudo-random numbers. 32-byte parity is appended to each column of the scrambled block to form an LDC (long distance code) block of 304 columns ×248 rows. This LDC block is interleaved to form a block of 152 columns ×496 rows (interleaved LDC block). Four 38 columns, separated by one column of the above BIS, are arrayed, as shown in FIG. 13, to form 155 columns×496 rows. 2.5 bytes of the frame synchronizing codes (frame sync) are appended at the leading end to form a 157.5 bytes×496 frame structure, with each row corresponding to a frame. Each row of FIG. 13 corresponds to 496 frames of Frame 10 to Frame 505 of a data area within each recording block (cluster), shown in FIG. 16, and which will be explained subsequently.

In the above data structure, data interleaving is of the block completion type. Thus, data redundancy is 20.50%. As the data detection system, the viterbi decoding system by the PR (1, 2, 1) ML is used.

The disc driving system of the next-generation MD1 is the CLV system, with the linear speed being 2.4 n/s. The standard data rate for recording/reproduction is 4.4 MB/s. By using the RLL (1-7) PP modulation system, in place of the EFM, the window margin is 0.666, in place of 0.5, thus raising the density by a factor of 1.33. On the other hand, the cluster, as the smallest data rewrite unit, is made up by 16 sectors (64 kB). By using the RS-LDC system with BIS, in place of the CIRC system, as the recording modulation system, and by using a system exploiting the difference in the sector structure and the viterbi decoding, the data efficiency is 79.5%, instead of 53.7%, thus raising the recording density by a factor of 1.48. If the values of these factors are taken together, the recording capacity of the next-generation MD1 may be 300 MB, which is approximately twice that of the conventional Mini-Disc.

On the other hand, the next-generation MD2 is a recording medium employing the high density recording technique, such as the magnetic wall displacement detection (DWDD) system, and which differs in the physical format from the conventional Mini-Disc and the next-generation MD1 described above. The next-generation MD2 has a track pitch of 1.25 μm and a bit length of 1.6 μm/bit and is increased in density in the line direction.

For compatibility with the conventional Mini-Disc and with the next-generation MD1, the standard for the optical system, readout system and the servo processing for the next-generation MD2 is unchanged from the standard so far used, with the laser wavelength λ=780 nm and the numerical aperture of the optical head NA=0.45. The recording system is the groove recording system, with the address system being a system exploiting the ADIP. The outer shape of the casing is of the same standard as that of the conventional Mini-Disc and the next-generation MD1.

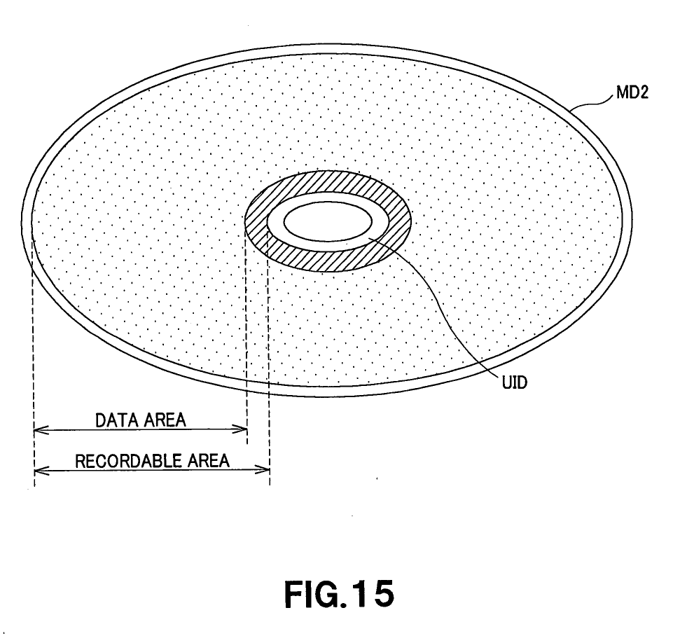

The next-generation MD2 does not use pre-bits, for raising the density, as shown in FIG. 15, and hence is not provided with a PTOC area by pre-bits. Moreover, the next-generation MD2 is provided with a UID area for recording the information for copyright protection, information for preventing data falsification and the UID which is to be the basis for other nonpublic information. The UID area is provided in a part of the disc disposed further inwardly of the lead-in area provided radially inwardly of the recordable area. The UID area is recorded in a recording system different from the DWDD system applied to the next-generation MD2.

The relationship between the ADIP sector structure and the data block of the next-generation MD1 and the next-generation MD2 is now explained with reference to FIG. 16. The conventional Mini-Disc (MD) system uses a cluster/sector structure associated with the physical address recorded as the ADIP. For convenience of explanation, the cluster based on the ADIP address is labeled ‘ADIP cluster’, while the cluster based on the address in the next-generation MD1 and the next-generation MD2 is labeled a ‘recording block’ or a ‘next-generation MD cluster’.

In the next-generation MD1 and the next-generation MD2, a data track is handled as a data stream recorded as a continuum of clusters as smallest address units, as shown in FIG. 16, whilst a recording block (primary generation MD cluster) is formed by 16 sectors or a ½ADIP cluster, as also shown in FIG. 16.

The data structure of the recording block (primary generation MD cluster), shown in FIG. 16, is made up by a 10-frame preamble, a 6-frame post-amble and a 496-frame data part, totaling at 512 frames. Each frame in this recording block is made up by a sync signal area, data, BIS and DSV.

Out of the 512 frames of each recording block, 31 frames, resulting from division of the 496 frames, in which to record significant data, into 16 equal parts, are each termed the address unit. The numbers of the address units are termed the address unit numbers (AUNs). This AUN is a number given each address unit and is used for address management of the recording signals.

In case the high density data, modulated in accordance with the 1-7 PP modulation system, are recorded on the conventional Mini-Disc, having the physical cluster/sector structure stated in the ADIP, such as the next-generation MD1, there is presented a problem that the ADIP address, intrinsically recorded on the disc, is not coincident with the address of the data block actually recorded. In the random access, carried out with the ADP address as reference, recorded data can be read out by accessing the vicinity of the location where the desired data has been recorded. However, in data writing, a correct location needs to be accessed in order not to overwrite or erase the recorded data. It is therefore crucial to accurately grasp the access position from the next generation MD cluster/next generation MD sector associated with the ADIP address.

Hence, with the next-generation MD1, a high density data cluster needs to be grasped by a data unit obtained on converting the ADIP address recorded as wobble on the medium surface in accordance with a preset rule. In this case, an integer number multiple of the ADIP sector is to be the high density data cluster. Based on this concept, each generation MD cluster is formed in the ½ ADIP cluster domain in stating the next-generation MD cluster in the 1 ADIP cluster recorded on the conventional Mini-Disc.

Thus, in the next-generation MD1, two clusters of the above-described next-generation MD cluster are associated as a smallest recording unit (recording block) with one ADIP cluster.

With the next-generation MD2, each cluster is handled as one recording block.

In the present embodiment, a data block of 2048 bytes, supplied from the host application, is one logical data sector (LDS), and a set of 32 logical data sectors, recorded in the same recording block, is a logical data sector (LDC).

With the above-described data structure, UMD data may be recorded with optimum timing on the recording medium, when it is desired to record the UMD data in an optional position. Moreover, by having an integer number of the next generation MD clusters contained in the ADIP cluster as the ADIP address unit, it is possible to simplify the rule of address conversion from the ADIP cluster address to the UMD data cluster address and hence the circuit for conversion or the software structure.

In FIG. 16, an example of associating two next-generation MD clusters with one ADIP cluster is shown. Alternatively, three or more next-generation MD clusters may be arranged in one ADIP cluster. In this case, one next-generation MD cluster need not be made up by 16 ADIP sectors, such that the number of the ADIP sectors making up the next-generation MD cluster may be set as the difference in the data recording density in the EFM modulation system and the RLL (1-7) PP modulation system, the number of sectors making up the next-generation MD cluster, or the sector size, is taken into account.

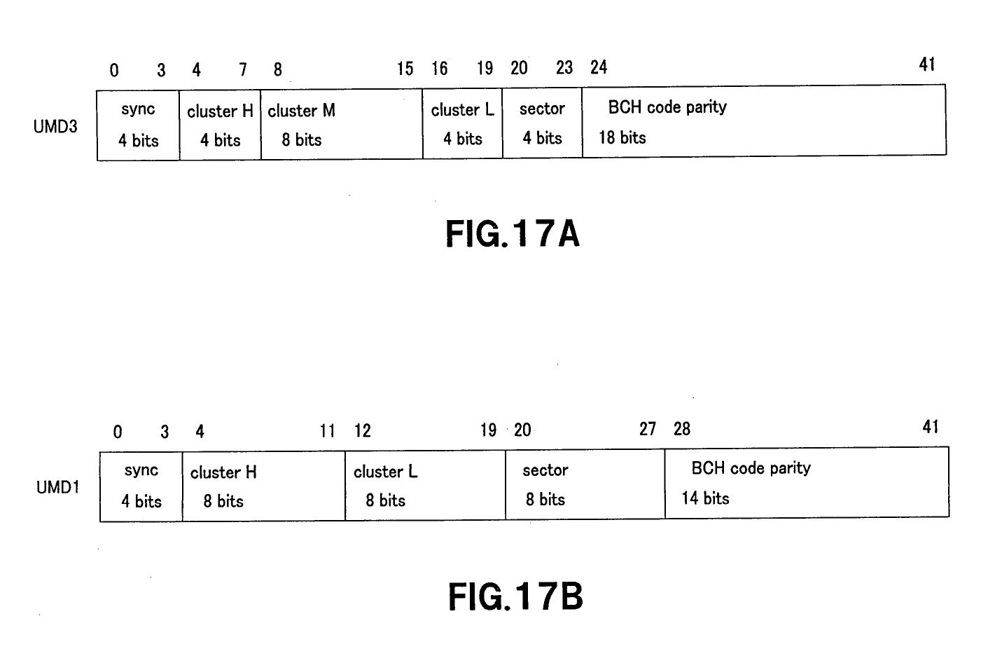

The ADIP data structure is now explained. FIGS. 17A and 17B show the data structure of the ADIP of the next-generation MD2 and, for comparison sake, the data structure of the ADIP of the next-generation MD1, respectively.

With the next-generation MD1, the sync signals, the cluster H information and the cluster L information, indicating e.g. the cluster number in the disc, and the sector information, including e.g. the sector number in the cluster, are recorded. The sync signals are recorded in 4 bits, the cluster H is recorded with upper 8 bits of the address information, the cluster L is recorded with lower 8 bits of the address information, and the sector information is recorded with 4 bits. The CRC is appended in the latter 14 bits. Hence, a sum total of 42 bits of the ADIP signals are recorded in a header part of each ADIP sector.

With the next-generation MD2, 4 bits of the sync signal data, 4 bits of the cluster H information, 8 bits of the cluster M information, 4 bits of the cluster 1 information and 4 bits of the sector information are recorded. The BCH parity is appended in the latter 18 bits. In similar manner, with next-generation MD2, 42 bits of the ADIP signals are recorded in the header part of each ADIP sector.

In the ADIP data structure, the cluster H information, the cluster M information and the cluster L information may be determined optionally. Other subsidiary information may also be recorded here. Thus, in the ADIP signal of the next-generation MD, it is possible to record the cluster information by the upper 8 bits of the cluster H and by the lower 8 bits of the cluster L and to record the disc control information in place of the cluster L information expressed by the lower 8 bits. The disc control information may be exemplified by the corrected value of the servo signal, an upper limit value of the replay laser power, a reproducing laser power line velocity correction coefficient, the recording magnetic sensitivity, the magnetic-laser pulse phase difference and the parity.

The processing for reproduction and recording by the disc drive device for the next-generation MD1 and the next-generation MD2, determined as to the disc type, is now explained in detail.

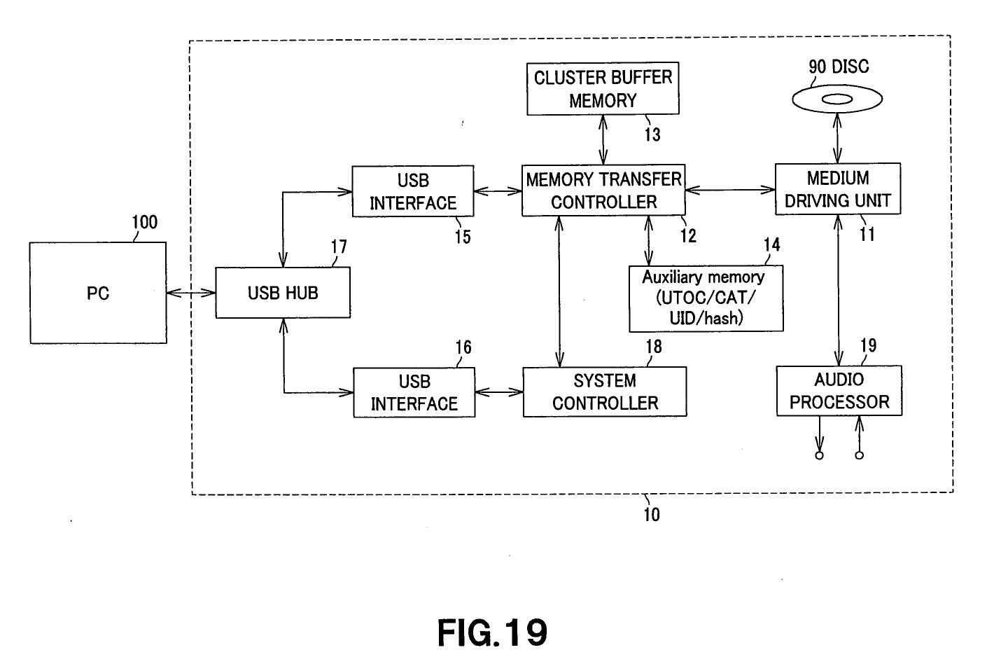

FIG. 19 shows the structure of a disc driving device 10 having the recording and/or reproducing unit 11 for the optical disc as a medium driving unit 11. The disc driving device 10 may be connected to a personal computer (PC) 100 and the next-generation MD1 and the next-generation MD2 may be used as an external storage for audio data and for the PC.

The disc driving device 10 includes the medium driving unit 11, a memory transfer controller 12, a cluster buffer memory 13, an auxiliary memory 14, a USB interfaces 15, 16, a USB hub 17, a system controller 18 and an audio processor 19, as shown in FIG. 19.

The medium driving unit 11 records and/or reproduces a variety of discs 90, such as conventional Mini-Disc, next-generation MD1 or the next-generation MD2 loaded in position. The inner structure of the medium driving unit 11 (recording and/or reproducing unit) is explained with reference to FIG. 12.

The memory transfer controller 12 controls transmission/ reception of reproducing data from the medium driving unit 11 or recording data supplied to the medium driving unit 11. The cluster buffer memory 13 buffers the data, read out from the data track of the disc 90 by the medium driving unit 11 in terms of the high density data cluster as a unit. The auxiliary memory 14 memorizes the management information of various sorts, such as UTOC data, CAT data, unique ID or the hash values, and the special information, under control by the memory transfer controller 12.

The system controller 18 may communicate with the PC 100, connected thereto via USB interface 16 and USB hub 17 to perform communication control with the PC 100 to receive a command for write or readout request or to send the necessary information, such as the status information, and to manage comprehensive control of the disc driving device 10 in its entirety.

If the disc 90 is loaded on the medium driving unit 11, the system controller 18 commands the medium driving unit 11 to read out e.g. the management information from the disc 90 to cause storage of e.g. the management information, such as the PTOC or the UTOC, read out by the memory transfer controller 12, in the auxiliary memory 14.

The system controller 18 reads-in the management information to grasp the recording state on the disc 90. The system controller also causes the CAT to be read in to grasp the structure of the high density data cluster in the data track to cope with an access request for a data track from the PC 100.

The system controller also executes disc authentication processing and other processing, by the unique ID or by the hash value, and sends these values to the PC 100 to execute disc authentication processing and other processing operations on the PC 100.

In case the system controller 18 has received a request for reading out a given FAT sector from the PC 100, the system controller 18 sends to the medium driving unit 11 a signal to the effect that the high density data cluster including the FAT sector is about to be executed. The high density data cluster read out is written by the memory transfer controller 12 in the cluster buffer memory 13. If the data of the FAT sector has already been stored in the cluster buffer memory 13, the readout by the medium driving unit 11 is unnecessary.

The system controller 18 generates a signal of reading out the requested FAT sector from the data of the high density data cluster, written in the cluster buffer memory 13, and performs control to send the signal to the PC 100 via USB interface 15 and USB hub 17.

In case a write request for a FAT sector is made from the PC 100, the system controller 18 causes the medium driving unit 11 to read out the high density data cluster including this FAT sector. The high density data cluster as read out is written by the memory transfer controller 12 in the cluster buffer memory 13. If the data of the FAT sector has already been stored in the cluster buffer memory 13, the readout by the medium driving unit 11 is unnecessary.

The system controller 18 sends the data (recording data) of the FAT sector, sent from the PC 100, via USB interface 15 to the memory transfer controller 12, to cause the rewriting of the data of the FAT sector in question on the cluster buffer memory 13.

The system controller 18 commands the memory transfer controller 12 to transfer the data of the high density data cluster, stored in the cluster buffer memory 13, as recording data to the medium driving unit 11. The high density data cluster is stored in the cluster buffer memory 13 in a state in which the FAT sector has been rewritten. In writing the recording data of the high density data cluster, the medium driving unit 11 modulates the recording data in accordance with the EFM system or with the RLL (1-7) PP modulation system in case the medium loaded is the conventional Mini-Disc or the next-generation MD1 or MD2, respectively.

Meanwhile, in the disc driving device 10, the above-described recording/reproduction control is the control for recording/reproducing the data track. In case the MD audio data (audio track) is to be recorded/ reproduced, data transfer is by the audio processor 19.

The audio processor 19 includes, as an inputting system, an analog voice inputting unit, such as a line inputting circuit/microphone inputting circuit, an A/D converter, and a digital audio data inputting unit. The audio processor 19 also includes an ATRAC compression encoder/decoder and a buffer memory for compressed data. The audio processor 19 also includes, as an outputting system, an analog voice signal outputting unit, such as a digital audio data outputting unit, a D/A converter and a line outputting circuit/headphone outputting circuit.

It is when digital audio data (or an analog voice signal) is entered to the audio processor 19 that the audio track is recorded on the disc 90. The input linear PCM digital audio data, or the linear PCM digital audio data entered as analog voice signals and subsequently converted by the A/D converter, is encoded by ATRAC compression and stored in a buffer memory. The data is then read out from the buffer memory at a preset timing (from one data unit corresponding to an ADIP cluster to another) and transferred to the medium driving unit 11.

The medium driving unit 11 modulates the compressed data, transferred thereto, in accordance with EFM, as the first modulation system, or with the RLL (1-7) PP modulation system, to write the so modulated data as an audio track on the disc 90.

In reproducing the audio track form the disc 90, the medium driving unit 11 demodulates the reproducing data into the state of the ATRAC compressed data to transfer the data to the audio processor 19. The audio processor 19 decodes the ATRAC compressed data into linear PCM audio data which is sent out at the digital audio data outputting unit. Or, the data is converted by the D/A converter into analog voice signals for line output/headphone output.

Meanwhile, the structure shown in FIG. 19 is merely exemplary and, in case the disc driving device 10 is connected to the PC for use as an external storage device adapted for recording/reproducing only the data track, the audio processor 19 is unneeded. If it is a principal object to record/reproduce audio signals, it is desirable to provide the audio processor 19, and an operating unit or a display as a user interface. For connection to the PC 100, a so-called IEEE 1394 interface conforming to the IEEE (Institute of Electrical and Electronic Engineers, Inc.) or a general connection interface may be used in place of the USB.

In accessing to a data area, a command for recording and/or reproducing data in terms of a [logical sector] (referred to below as FAT sector) as a unit is issued from the external PC 100 through the USB interface 16 to the system controller 18 of the disc driving device 10. To the PC 100, it appears as if the data cluster is divided in terms of 2048 bytes as a unit, and is supervised in accordance with the FAT file system in the increasing order of the USN, as shown in FIG. 19. On the other hand, the minimum rewrite unit of the data track in the disc 90 is the next generation MD cluster, having the size of 65,536 bytes, and the LCN is given to this next generation MD cluster.

The size of the data sector, referenced by the FAT, is smaller than that of the next generation MD cluster. It is therefore necessary for the disc driving device to convert the user sector, referenced by the FAT, into a physical ADIP address, and to convert read/write, in terms of the data sector, referenced by the FAT, into read/write in terms of the next generation MD cluster based read and write, using the buffer memory 13.

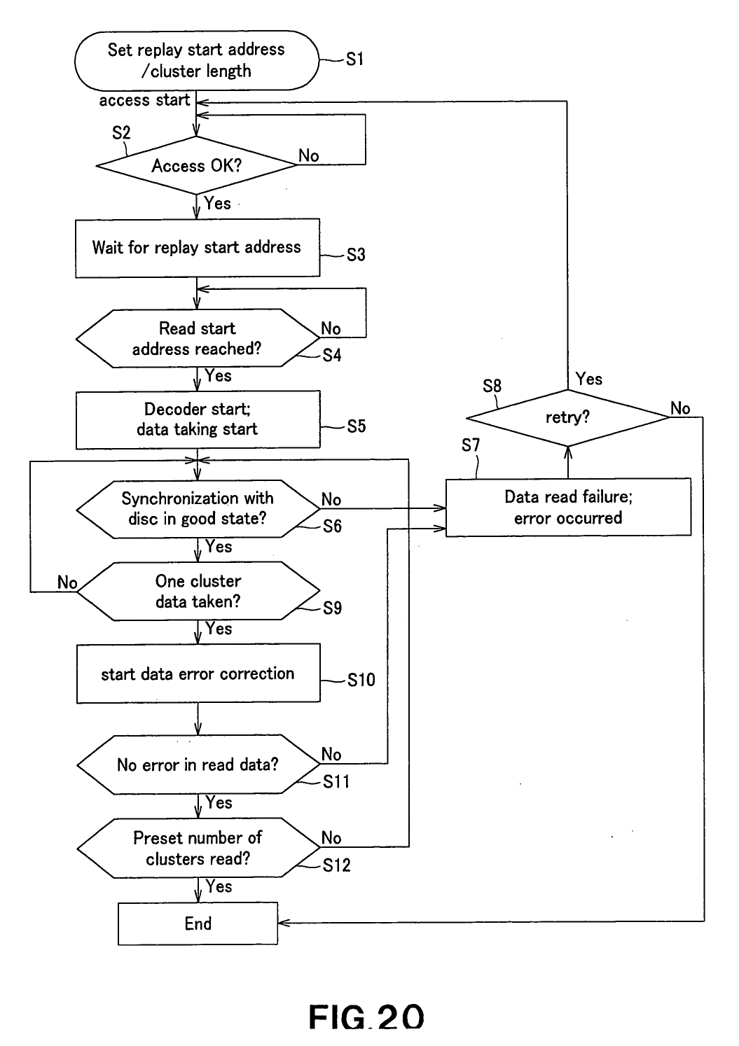

FIG. 20 shows the processing in the system controller 18 in the disc driving device 10 in case a request for readout of a certain FAT sector from the PC 100.

On receipt of a readout command for reading out the FAT sector #n from the PC 100 via USB interface 16, the system controller 18 performs the processing of finding the next generation MD cluster number containing the FAT sector of the specified FAT sector number #n.

The provisional next generation MD cluster number u0 is determined. Since the size of the next generation MD cluster is 65536 bytes and the size of the FAT sector is 2048 bytes, there are 32 FAT sectors in the first generation MD cluster. Thus, the FAT sector number (n) divided by an integer 32, with the remainder being truncated (u0), represents the provisional next generation MD cluster number.

The system controller then references the disc information, read-in from the disc 90 into the auxiliary memory 14, to find the number of the next generation MD cluster ux other than the clusters for data recording. This number is the number of the next generation MD clusters of a secure area.

Among the next generation MD clusters within the data track, there is a cluster that is not laid open as being a data recordable/reproducible area. Thus, the nonpublic number of clusters, i.e. the number of clusters not laid open (ux) is found based on the disc information previously read into the auxiliary memory. The number of clusters not laid open ux is then summed to the cluster number u0 of the next generation MD cluster number to give a sum u which is to be the actual next generation MD cluster number #u.

When the next generation MD cluster number #u, including the FAT sector number #n, is found, the system controller 18 determines whether or not the next generation MD cluster of the cluster number #u has already been read out and stored in the cluster buffer memory 13. If the cluster has not been stored, it is read out from the disc 90.

The system controller 18 finds the ADIP address #a from the next generation MD cluster number #u as read out to read out the next generation MD cluster from the disc 90.

The next generation MD cluster may be recorded in plural parts on the disc 90. For this reason, these parts need be retrieved sequentially in order to find the actually recorded ADIP address. The number of the MD clusters of the next generation and the number of the leading next generation MD cluster px, recorded in the leading part of the data track, are found from the disc information read out in the auxiliary memory 14.

Since the start address/end address are recorded in the respective parts by the ADIP address, the number of the next generation MD clusters p and the leading next generation MD cluster px may be found from the disc information read out into the ADIP cluster address and the part length. It is then verified whether or not the next generation MD cluster of the targeted cluster number #u is included in this part. If the cluster is not included in the part, the next part is checked. This next part is that part which is specified by the link information of the part which has thus far been of interest. In this manner, the parts stated in the disc information are sequentially retrieved to determine the part containing the next generation MD cluster of interest.

When the part having recorded the next generation MD cluster of interest (#u) is found, the difference between the cluster number px of the next generation MD cluster recorded in the leading end of this part thus found and the cluster number #u of the next generation MD cluster of interest is found to find the offset from the leading end of the part to the next generation MD cluster (#u) of interest.

Since two next generation MD clusters are written in this case in one ADIP cluster, the offset may be converted into the ADIP address offset f by dividing the offset by 2(f=(u−px)/2).

However, if a fractional number of 0.5 is obtained, writing is from the mid part of the cluster f. Ultimately, the offset f is added to a cluster address part in the start address of the part to find the ADIP address #a of the destination of recording in which to actually write the next generation MD cluster #u. The above corresponds to the processing of setting the replay start address and the cluster length in the step S1. It is here assumed that decision as to whether the medium is the conventional Mini-Disc, next-generation MD1 or the next-generation MD2 has already been finished by another particular technique.

When the ADIP address #a has been found, the system controller 18 commands the medium driving unit 11 to access to the ADIP address #a. The medium driving unit 11 then accesses the ADIP address #a, under control by the driving controller 41.

In a step S2, the system controller 18 awaits the access completion. On access completion, the system controller 18 awaits the optical head 22 reaching the targeted replay start address. If, in a step S4, the system controller has ascertained that the replay start address has been reached, the system controller commands the medium driving unit 11 to start reading out one cluster of data of the next generation MD cluster.

Responsive thereto, the medium driving unit 11 commences to read out data from the disc 90, under control by the driving controller 41. The read-out data are output by a replay system of the optical head 22, RF amplifier 24, RLL (1-7) PP demodulating unit 35 and the RS-LDC decoder 36 and thence routed to the memory transfer controller 12.

In a step S6, the system controller 18 verifies whether or not synchronization with respect to the disc 90 has been in good order. If the synchronization with respect to the disc 90 is not in good order, a signal indicating the purport of occurrence of a data readout error is generated in a step S7. If, in a step S8, it is determined that readout is to be performed again, the step as from step S2 is repeated.

When one cluster data has been acquired, the system controller 18 in a step S10 commences correcting the acquired data for errors. If, in a step S11, there is an error in the acquired data, the system controller 18 reverts to a step S7 to generate a signal indicating that a data readout error has occurred. If there is no error in the acquired data, it is verified in a step S12 whether or not a preset cluster has been acquired. When the preset cluster has been acquired, the sequence of processing operations is terminated. The system controller 18 awaits the readout operation by the medium driving unit 11 to store data read out and supplied to the memory transfer controller 12 in the cluster buffer memory 13. When the preset cluster has not been acquired, the process as from the step S6 is repeated.

One cluster data of the next generation MD cluster, read into the cluster buffer memory 13, includes plural FAT sectors. Thus, from these FAT sectors, the storage location of data of the requested FAT sector is found and data of one FAT sector (2048 bytes) are sent out from the USB interface 15 to the external PC 100. Specifically, the system controller 18 finds, from the requested FAT sector number #n, a byte offset #b within the next generation MD cluster containing this sector. The system controller causes data for one FAT sector (2048 bytes) to be read out from the location of the byte offset #b in the cluster buffer memory 13, to transfer the so read-out data via USB interface 15 to the PC 100.

By the above processing, the next generation MD sector may be read out and transferred responsive to a readout request for one FAT sector from the PC 100.

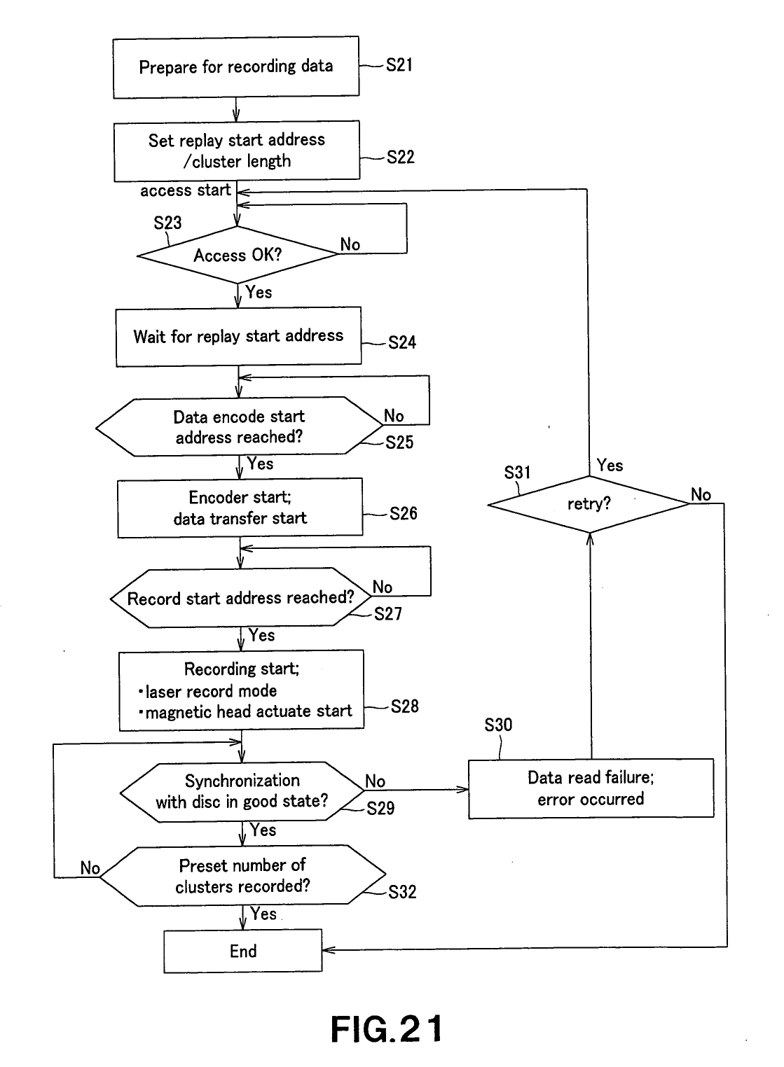

Referring to FIG. 21, the processing by the system controller 18 in the disc driving device 10 in case a write request for a given FAT sector is made from the PC 100 is now explained.

On receipt of a write command for the FAT sector #n via USB interface 16 from the PC 100, the system controller 18 finds the next generation MD cluster number containing the FAT sector of the FAT sector number #n, specified as described above.

When the next generation MD cluster number #u, including the FAT sector number #n, is found, the system controller 18 verifies whether or not the next generation MD cluster of the cluster number #n thus found has already been read out from the disc 90 and stored in the cluster buffer memory 13. If the cluster has not been stored, the processing for reading out the next generation MD cluster of the cluster number #u is performed. That is, the system controller 18 commands the medium driving unit 11 to read out the next generation MD cluster of the cluster number #u to store the so read out next generation MD cluster in the cluster buffer memory 13.

Thus, from the FAT sector number #n, requested for writing, the system controller 18 finds the byte offset #b in the next generation MD cluster containing the sector. The system controller 18 then receives 2048 byte data, as write data for the FAT sector #n, transferred from the PC 100, via USB interface 15, and causes the data corresponding to one FAT sector data (2048 bytes) from the position of the byte offset #b in the cluster buffer memory 13.

In this manner, only the FAT sector (#n), specified by the PC 100, among the data of the next generation MD cluster (#u), stored in the cluster buffer memory 13, is in a rewritten state. The system controller 18 then prepares for writing the next generation MD cluster (#u), stored in the cluster buffer memory 13, on the disc 90. The above is the process in a step S21 for making preparations for the recording data. It is again assumed that decision as to the medium type has already been completed by another particular technique.

In the next step S22, the system controller 18 sets, from the number #u of the next generation MD cluster to be written, an ADIP address #a of the recording start position. When the ADIP address #a has been found, the system controller 18 commands the medium driving unit 11 to access to the ADIP address #a. This causes the medium driving unit 11 to access to the ADIP address #a, under control by the driving controller 41.

If it is ascertained in a step S23 that the access has come to a close, the system controller 18 waits until the optical head 22 reaches the replay start address of interest. If it is ascertained in a step S25 that the data encode address has been reached, the system controller 18 in a step S26 commands the memory transfer controller 12 to start transfer to the medium driving unit 11 of data of the next generation MD cluster (#u) stored in the cluster buffer memory 13.

When it is ascertained in a step S27 that a recording start address has been reached, the system controller 18 in a step S28 commands the medium driving unit 11 to start writing data of the next generation MD cluster on the disc 90. Responsive thereto, the medium driving unit 11 starts writing data on the disc 90, under control by the driving controller 41. That is, the data transferred from the memory transfer controller 12 is recorded by a recording system composed of the RS-LDC encoder 47, RLL (1-7) PP modulating unit 48, magnetic head driver 46, magnetic head 23 and the optical head 22.

The system controller 18 in a step S29 verifies whether or not synchronization with respect to the disc 90 is in good order. If synchronization with respect to the disc 90 is out of order, the system controller 18 in a step S30 generates a signal to the effect that a data readout error has occurred. If it is determined in a step S31 that readout is again executed, the process as from the step S2 is repeated.

When one cluster data has been acquired, the system controller 18 in a step S32 checks whether or not a preset cluster has been acquired. When a preset cluster has been acquired, the sequence of operations is terminated.

By the above-mentioned processing, writing the FAT sector data on the disc 90 responsive to the write request for one FAT sector from the PC 100 may be achieved. That is, the FAT sector based writing is executed as rewriting of the next generation MD cluster unit, insofar as the disc 90 is concerned.

The present invention is not limited to the embodiments described with reference to the drawings and, as may be apparent to those skilled in the art, various changes, substitutions or equivalents may be envisaged without departing from the scope and the purport of the invention as defined in the appended claims.

### INDUSTRIAL APPLICABILITY

With the recording medium according to the present invention, an area in which to record the intrinsic identification information may be provided to a location not obstructive to increasing the recording capacity in a manner not complicating the mechanism or processing for readout.

With the method and device for reproducing a recording medium, according to the present invention, the identification information proper to a recording medium, provided to a location not obstructive to increasing the recording capacity, may be reproduced without complicating the readout mechanism or readout processing.

With the method for recording the intrinsic identification information, according to the present invention, the identification information proper to a recording medium may be recorded extremely readily.

With the method for recording the intrinsic identification information, according to the present invention, data may be recorded on the recording medium as reference is made to the identification information proper to a recording medium.

1. A recording medium having a first area in which a track for data recording is formed in a wobbled manner and a second area in which no track for data recording is formed in a wobbled manner, wherein
the intrinsic identification information for identifying the recording medium itself is recorded in said second area.

2. The recording medium according to claim 1 wherein the track in said first area is wobbled based on a signal modulated in keeping with the address information specifying data recording positions and wherein said intrinsic identification information is recorded with a format which is the same as the format of said address information.

3. The recording medium according to claim 2 wherein the track in said first area is wobbled based on an address signal modulated by frequency modulation of a carrier of a preset frequency in keeping with the address information specifying the data recording positions.

4. The recording medium according to claim 1 wherein the intrinsic identification information is recorded magneto-optically.

5. The recording medium according to claim 1 wherein the intrinsic identification information is recorded a plural number of times.

6. The recording medium according to claim 5 wherein the recording medium is disc-shaped and wherein the recording start position of said intrinsic identification information is located on a radial line on a recording surface of said recording medium.

7. The recording medium according to claim 6 wherein the intrinsic identification information recorded a plural number of times is recorded concentrically and/or spirally so that one intrinsic identification information is adjacent to another intrinsic identification information.

8. The recording medium according to claim 1 wherein the information recorded in said first area is read out in accordance with the magnetic wall displacement detection system and wherein the intrinsic identification information recorded in said second area is read out by a method different from the magnetic wall displacement detection system.

9. The recording medium according to claim 1 wherein said second area is provided radially inwardly of said first area.

10. A method for reproducing a recording medium having a first area in which a track for data recording is formed in a wobbled manner and a second area in which no track for data recording is formed in a wobbled manner and in which the intrinsic identification information for identifying the recording medium itself is recorded, said method comprising
causing movement of an optical head mechanism, having laser light illuminating means for illuminating laser light on said recording medium, to said second area; and
reading out the intrinsic identification information from the return light of the laser light illuminated from said laser light illuminating means on said optical recording medium.

11. A reproducing apparatus for a recording medium having a first area in which a track for data recording is formed in a wobbled manner and a second area in which no track for data recording is formed in a wobbled manner, and in which the intrinsic identification information for identifying the recording medium itself is recorded, said apparatus comprising
an optical head mechanism having laser light illuminating means for illuminating laser light on said recording medium;
readout means for reading out the intrinsic identification information from the return light of the laser light illuminated from said laser light illuminating means of said optical head mechanism to said optical recording medium; and
optical head mechanism controlling means for causing movement of said optical head mechanism to said second area to cause said readout means to read out said intrinsic identification information.

12. The reproducing apparatus for a recording medium according to claim 11 wherein
said track is wobbled based on an address signal modulated by frequency modulation of a carrier of a preset frequency in keeping with the address information specifying data recording positions, said intrinsic identification information being recorded with the same format as the format of the address information; and wherein
said readout means detects the address information from said wobbled track.

13. The reproducing apparatus for a recording medium according to claim 12 wherein
said optical head controlling means detects the boundary between said first area and the second area based on the address information detected by said readout means to cause said optical head mechanism to be moved to said second area.

14. A method for recording the intrinsic identification information for identifying a recording medium itself in a second area of said recording medium where no wobbled track is formed, said recording medium also having a first area in which a data recording track is formed in a wobbled manner.

15. The method for recording the intrinsic identification information according to claim 14 wherein said track in said first area is wobbled based on an address signal modulated by frequency modulation of a carrier of a preset frequency in keeping with the address information specifying data recording positions, and wherein said intrinsic identification information is recorded with the same format as the format of the address information.

16. The method for recording the intrinsic identification information according to claim 14 wherein the intrinsic identification information is recorded magneto-optically.

17. The method for recording the intrinsic identification information according to claim 14 wherein the intrinsic identification information is recorded a plural number of times.

18. The method for recording the intrinsic identification information according to claim 17 wherein the recording medium is disc-shaped and wherein the recording start position of said intrinsic identification information is located on a radial line on a recording surface of said recording medium.

19. The method for recording the intrinsic identification information according to claim 18 wherein, in recording said intrinsic identification information, said recording medium is run in rotation at a preset angular velocity.

20. The method for recording the intrinsic identification information according to claim 19 wherein the intrinsic identification information recorded a plural number of times is recorded concentrically and/or spirally so that one intrinsic identification information is adjacent to another intrinsic identification information.

21. The method for recording the intrinsic identification information according to claim 14 wherein said second area is provided radially inwardly of said first area.

22. An apparatus for recording a recording medium having a first area in which a track for data recording is formed in a wobbled manner and a second area in which no track for data recording is formed in a wobbled manner, said apparatus comprising
an optical head mechanism having laser light illuminating means for illuminating laser light on said recording medium; and
optical head mechanism controlling means for causing movement of said optical head mechanism to said second area and for illuminating laser light by said laser light illuminating means to cause the writing of the intrinsic identification information for identifying said recording medium in said second area.
